(19) United States
(12) Patent Application Publication
(10) Pub. No.: US 2010/0125640 A1
(43) Pub. Date: May 20, 2010

(54) Traffic Management Apparatus

(75) Inventors: Mark Boddington, Bedfordshire (GB); Nicholas Bond, Essex (GB)

Correspondence Address: RICHARD M. GOLDBERG, 25 EAST SALEM STREET, SUITE 419, HACKENSACK, NJ, 07601, US

(73) Assignee: ZEUS TECHNOLOGY LIMITED, Cambridge (GB)

(21) Appl. No.: 12/615,340

(22) Filed: Nov. 10, 2009

(30) Foreign Application Priority Data
Nov. 14, 2008 (EP) 08253730.9

(51) Int. Cl. G06F 15/16

(52) U.S. Cl. 709/206; 709/235; 709/219

(57) ABSTRACT

A traffic management apparatus for connection within a data transmission network is disclosed, that is arranged to manage the distribution of data traffic between data serving computers and the data relaying devices by analysing client requests. The apparatus has an input device (401), a data processing device (402) and an output device (403). The input device (401) is configured to receive electronic mail communications that include body text and one or more original file attachments in the form of executable programs. The processing device selects (803) original file attachments that are executable programs to produce selected file attachments. The processing device adds (805) a textural notice to the body text to the effect that an executable file is included as an attachment. The processing device compresses (806) the selected file attachment to produce compressed file attachments. The processing device replaces (808) the selected file attachments with the compressed file attachments to produce a modified electronic mail communication. The output device (403) conveys (810) the modified mail electronic mail communication with the compressed attachments to a receiving server computer.

### CROSS REFERENCE TO RELATED APPLICATIONS

This application claims priority from European patent application number 08253730.9, files Nov. 14^{th} 2008 the entire disclosure of which is incorporated herein by reference.

### BACKGROUND OF THE INVENTION

1. Field of the Invention

The present invention relates to a traffic management apparatus for connection within a data transmission network arranged to manage the distribution of data traffic between a plurality of data serving computers and data relaying devices by analysing client requests, comprising an input device, a data processing device and an output.

2. Description of the Related Art

Systems for the creation and distribution of electronic mail are well known and well established. It is known to include mail servers connected to the Internet which effectively store and forward mail messages. Thus, an electronic mail system may be considered in terms of its storage requirements and its transmission bandwidth between nodes.

Traffic management systems are known as described in British patent number 2 413 868 (U.S. patent application Ser. No. 11/124,807) and British patent number 2 414 136 (U.S. application Ser. No. 11/124,835). These systems are directed towards the management of traffic over the Internet.

The compression of data communicated in an electronic message is disclosed in US 2005044158. Files attached to an electronic communication are compressed based on an examination of the file type and an identification of an alternative compressed file type. Thus, the first original file type is compressed into a second preferred compressed file type for the purpose of streamlining the package to be delivered in the communication.

A problem with the adoption of file compression within the Internet exists in terms of identifying an appropriate platform for the compression to take place.

Problems also exist in that after compression has taken place the recipient is no longer aware as to the nature of the data that has been transmitted. In particular, problems occur when executable programs are compressed in this way.

According to an aspect of the present invention, there is provided a traffic management apparatus for connection within a data transmission network arranged to manage the distribution of data traffic between a plurality of data serving computers and data relaying devices by analysing client requests, comprising an input device, a data processing device and a output device. The input device is configured to receive electronic mail communications that include body text and one or more original file attachments in the form of executable programs. The processing device selects the original file attachments that are executable programs to produce selected file attachments. The processing device is also configured to add a textural notice to the body text to the effect that an executable file is included as an attachment. The processing device then compressErs the selected file attachment to produce compressed file attachments whereafter the processing device replaces the selected file attachments with the compressed file attachments to produce a modified electronic mail communication. The output device then conveys the modified electronic mail communication with the compressed attachments to a receiving server computer.

### BRIEF DESCRIPTION OF THE SEVERAL VIEWS OF THE DRAWINGS

FIG. 1 shows an environment for the transmission of electronic mail communications;

FIG. 2 illustrates the environment of FIG. 1 embodying the present invention;

FIG. 3 shows a portion of a distributed communications network;

FIG. 4 illustrates a first embodiment in which compression procedures are performed at a server;

FIG. 5 illustrates an alternative embodiment in which procedures are implemented within a traffic management apparatus;

FIG. 6 shows a hardware platform for the traffic management system identified in FIG. 5;

FIG. 7 illustrates the functionality of the environment illustrated in FIG. 5; and

FIG. 8 shows the procedures performed within the embodiment of FIG. 7.

### DESCRIPTION OF PREFERRED EMBODIMENTS OF THE INVENTION

Embodiments of the invention will be described by way of example only. As such, this description should not be considered as limiting the scope of the invention, which is as set out in the appended claims.

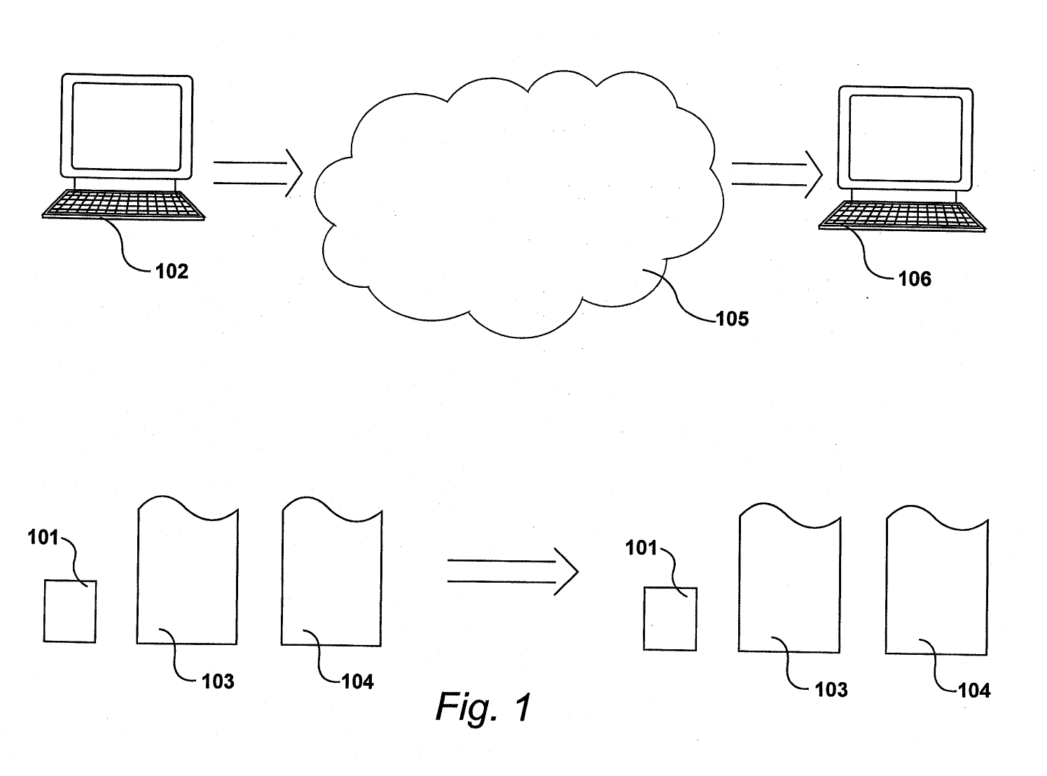

### FIG. 1

An environment for the transmission of electronic mail communications through a distributed network (such as the Internet) is illustrated in FIG. 1. An electronic mail communication 101 is generated at an originating station 102. In addition to the text of the email communication 101, the communication also includes a first file attachment 103 and a second file attachment 104.

Communication takes place through distributed network 105 resulting in the communication being received at a receiving station 106. In accordance with this process, the original electronic communication 101 is received, along with its first attachment 103 and its second attachment 104.

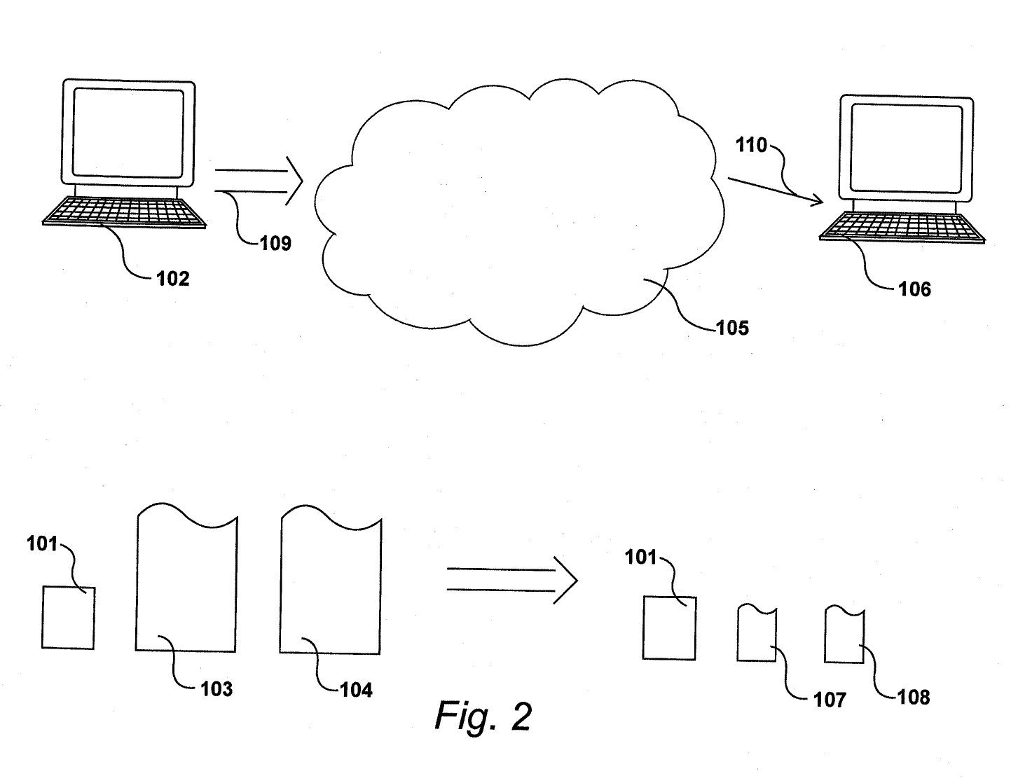

### FIG. 2

An embodiment of the invention is illustrated in FIG. 2 in which the same electronic communication 101 with its first attachment 103 and its second attachment 104 has been transmitted from originating station 102 via the network 105 to the receiving station 106.

At the receiving station 106 the electronic communication 101 has been received. However, although the information contained within attachments 103 and 104 has been received, the actual data contained therein has been compressed such that instead of receiving full bandwidth files 103 and 104, compressed files 107 and 108 have been received.

The original transmission of the communication to network 105 is illustrated by large arrow 109, representing a communication that requires a relatively high bandwidth. However, the communication from the network 105 to the receiving station 106 is illustrated as a small arrow 110, representing the reduction in bandwidth requirement for the transmission of the compressed files 107, 108.

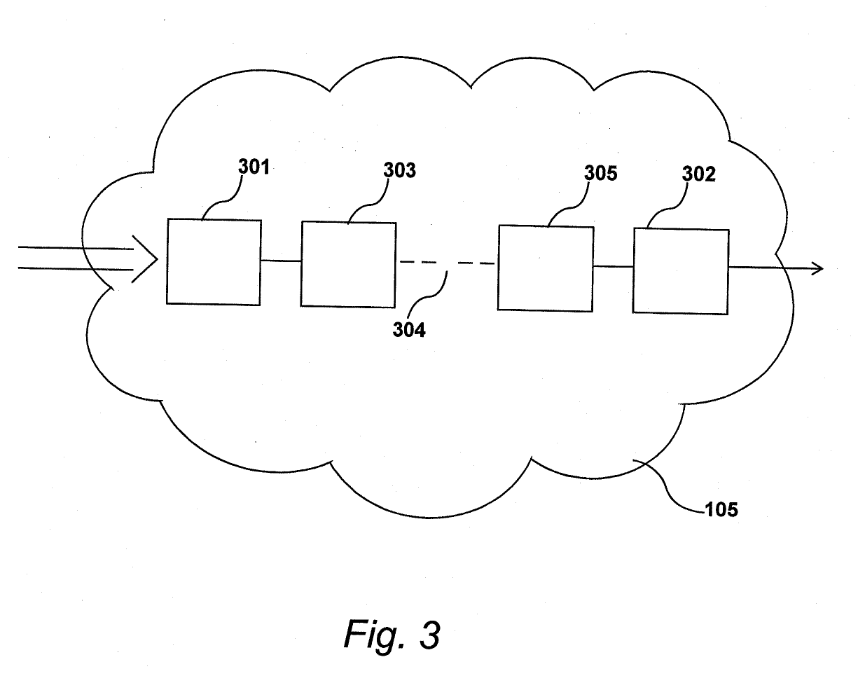

### FIG. 3

A portion of the distributed communications network 105 is illustrated in FIG. 3. A first node or location 301 may be considered to represent an email server that provides email services to the originator 102. Similarly, location 302 may be considered as an email server providing email services to the receiving station 106. Many additional nodes or locations are included within the network 105 and a selection of these locations will be called upon to effect the transmission of the communication through the network. Thus, additional nodes or servers within the network effectively perform a store and forward procedure for the electronic communication and as such their transmission may take place under the control of various technical processes primarily aimed at enhancing the overall efficiency of the network. Thus, for illustrative purposes, the communication is shown being received at a second node 303 after being handled by the first location 301. Communication takes place through a variety of nodes, illustrated by broken line 304, before being received at a third node 304 which in turn passes the communication to the server 302 providing services to the receiving station 106.

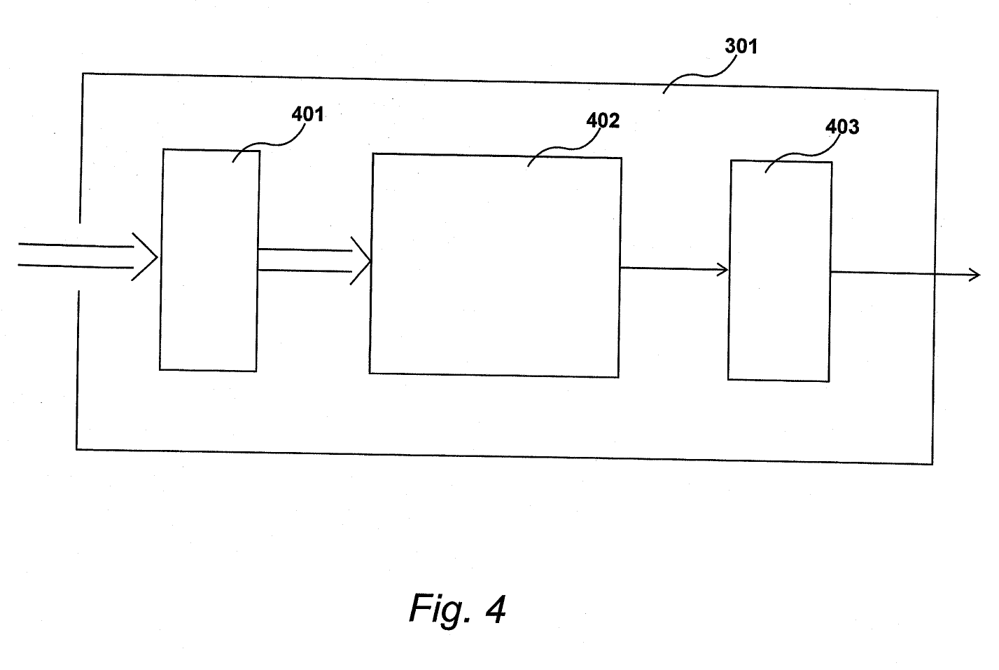

### FIG. 4

In a first embodiment, compression procedures are effected at server 301, this being the server that provides electronic mail services to the originator. Email server 301 is detailed in FIG. 4.

An input device 401 is configured to receive an original electronic mail communication which, for the purposes of this illustration, is assumed to contain a plurality of file attachments, such as file attachments 103 and 104. A processing device 402 is configured to identify one or more of the file attachments and to select one or more of the file attachments for compression. The processing device 402 is then configured to compress the selected attachment or attachments and to replace these selected attachments with the compressed versions so as to produce a modified communication.

An output device 403 is arranged to convey the modified electronic mail communication with the compressed attachments to a receiving server. Thus, in this preferred embodiment, output device 403 would be arranged to transmit the modified communication to location 303.

In an alternative embodiment, the compression procedures are performed within the core of the network 105 such that, for example, the compression procedures could be effected at location 303 or at location 305.

In an alternative embodiment, the compression procedures are effected at a mail server (mail server 303) that provides electronic mail services to the receiving station 106. However, it can be appreciated that greater benefit is derived from the compression process if it can be performed as soon as possible, therefore a preferred platform is the originating email server 301.

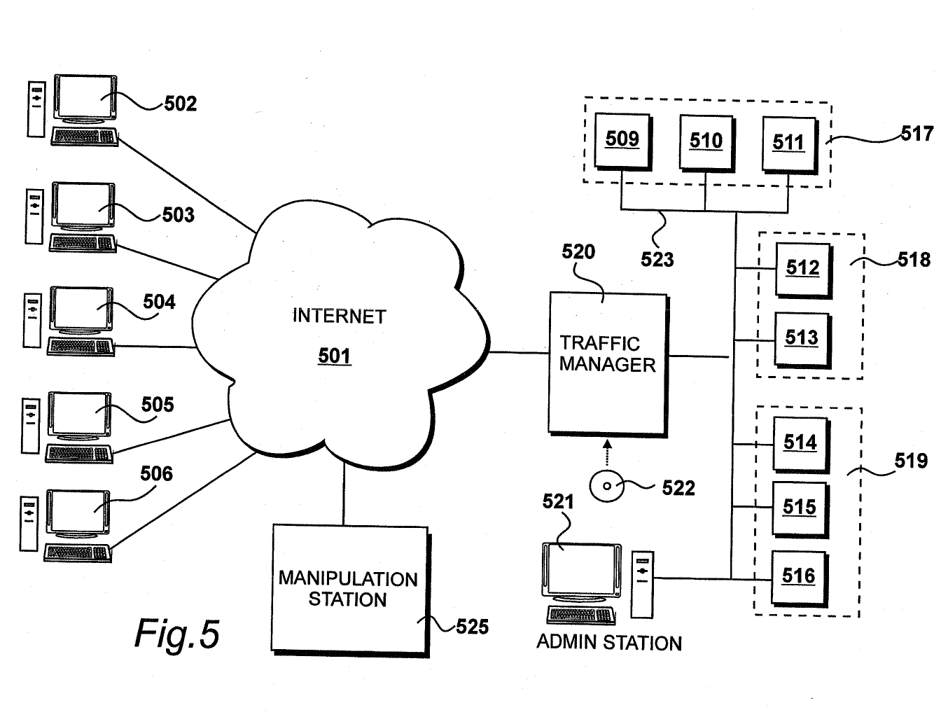

### FIG. 5

In a preferred embodiment, the compression procedures are implemented within a traffic management apparatus in which the traffic management apparatus itself is configured for collection within a data transmission network so as to manage the distribution of data traffic between a plurality of data serving and data relaying devices. Thus, the traffic management apparatus provides a platform within the Internet upon which the data compression procedures may be implemented.

A typical example of a traffic management apparatus is shown in FIG. 5 in which communications between servers and clients are provided by the Internet 501. Five clients 502 to 506 are shown, although it should be appreciated that this is merely representative of the many thousands of clients requesting data from servers. These clients include personal computers equipped with email and browsing software. Client devices also include mobile wireless communication devices such as portable computers, personal digital assistants and sophisticated mobile telephones.

Physical serving devices (servers) 509 to 516 are organised in three server pools 517, 518 and 519. In this example, the first pool 617 is for secure servers running secure protocols suitable for online sales and other secure transactions. Server pool 518 provides web pages and the third pool 519 is dedicated to electronic mail communications. However, it should be appreciated that this merely represents an example and that many configurations of this type are possible.

A traffic management system 520 monitors client requests and directs requests to an appropriate server pool. To do this, the system is provided with functionality enabling it to analyse client requests in detail. Furthermore, additional operations are carried out by the traffic management system (during and after request analysis) in order to maintain a high number of simultaneously connected clients without overloading any of the servers 509 to 516.

In order to facilitate the configuration of the servers and the traffic management system 520, an administration station 521 is provided, having human interface peripheral equipment including a monitor and a keyboard etc. A data carrying medium such as a DVD 522 is illustrated as a means for supplying executable instructions for the traffic managing process to a traffic manager platform. Alternatively, traffic managing instructions may be loaded onto the traffic management system from the Internet and the transfer of such instructions may be controlled via the administration system 521. A network 523 connects the servers 509 to 516 with a traffic management system 520 and to the Internet. Thus, in this embodiment, the traffic management system is implemented by a programmable platform having executable instructions installed thereon.

The example also shows the provision of a manipulation station 525 which may be provided within the environment of the traffic manager 520 or communication may take place over a substantial distance via an Internet connection, as illustrated in FIG. 5. The manipulation station represents an alternative environment to that of the traffic manager 520 and communication between the traffic manager 520 and the manipulation station 525 takes place using Internet protocol (TCP/IP) thereby allowing each environment to be developed independently. Thus, an environment provided at manipulation station 125 may be configured to facilitate the data compression procedures required by an aspect of the present invention.

The servers 509 to 516 are each configured to supply web page data to a plurality of requesting clients or to facilitate the transmission of electronic mail communications. The traffic manager 520 is configured to receive requests from clients and to select one of the serving devices for satisfying the requirements of that request. In a preferred embodiment, when data compression is required, the traffic manager 520 supplies a function call to the data manipulation station 525 that includes the original non-compressed data file. The manipulation station 525 manipulates the original data file so as to produce manipulated data in the form of a compressed file which is then returned to the traffic manager 120. In a preferred embodiment, the whole of the communication including the original email and all attachments are supplied to the manipulation station which then invokes all measures, including file selection and compression such that a modified electronic communication with compressed attachments is returned to the traffic manager. Alternatively, the manipulation station is used to perform compression upon selected files.

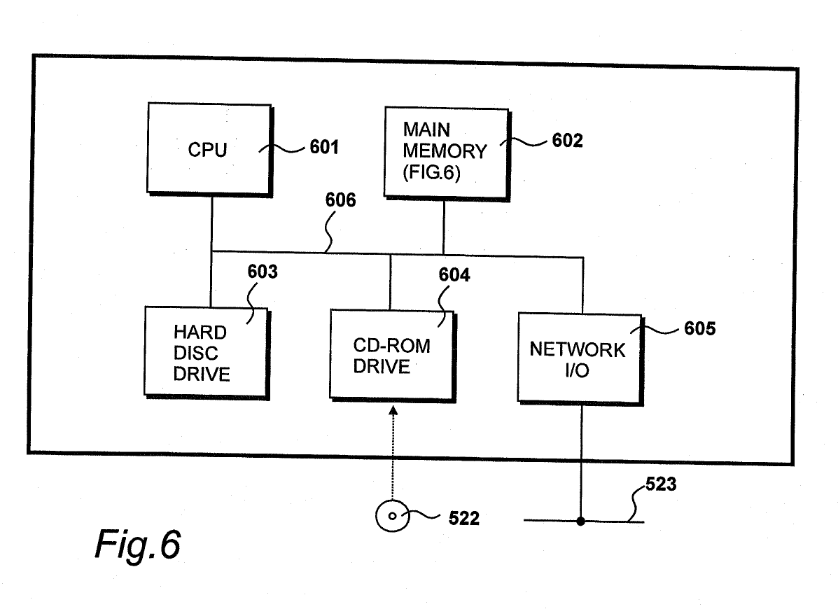

### FIG. 6

Instructions for the implementation of traffic management are executed on a hardware platform such as the computer system illustrated in FIG. 6. The traffic management platform is controlled by the administration system computer 521 and therefore does not require its own output monitor or input keyboard. Typically, hardware of this type is in the form of a rack mounted unit and several such units may be provided within a rack so as to provide a degree of redundancy in case of hardware failure. It should also be appreciated that server computers 509 to 516 may be configured in a similar fashion either locally, at an alternative site or distributed globally.

A central processing unit 601 is provided along with memory devices 602 to facilitate the storage of instructions and data that allows regular access while the system is in operation. A hard disc drive 603 is included to provide non-volatile storage of instructions and configuration data. Disc drive 603 also provides access to infrequently used data during operation. Upon system initialisation, configuration files and executable instructions are loaded from disc drive 603 and stored in main memory 602.

For the optional loading of traffic managing instructions from data carrying media, a DVD drive 604 is provided and this is configured to receive instructions from an instruction carrying medium such as DVD disc 522. In addition, one or more network connections are provided by at least one network interface 605 thereby allowing the traffic management system to connect to the local network 523 and to the Internet. Internally, devices 601 to 605 are connected via a data bus 206.

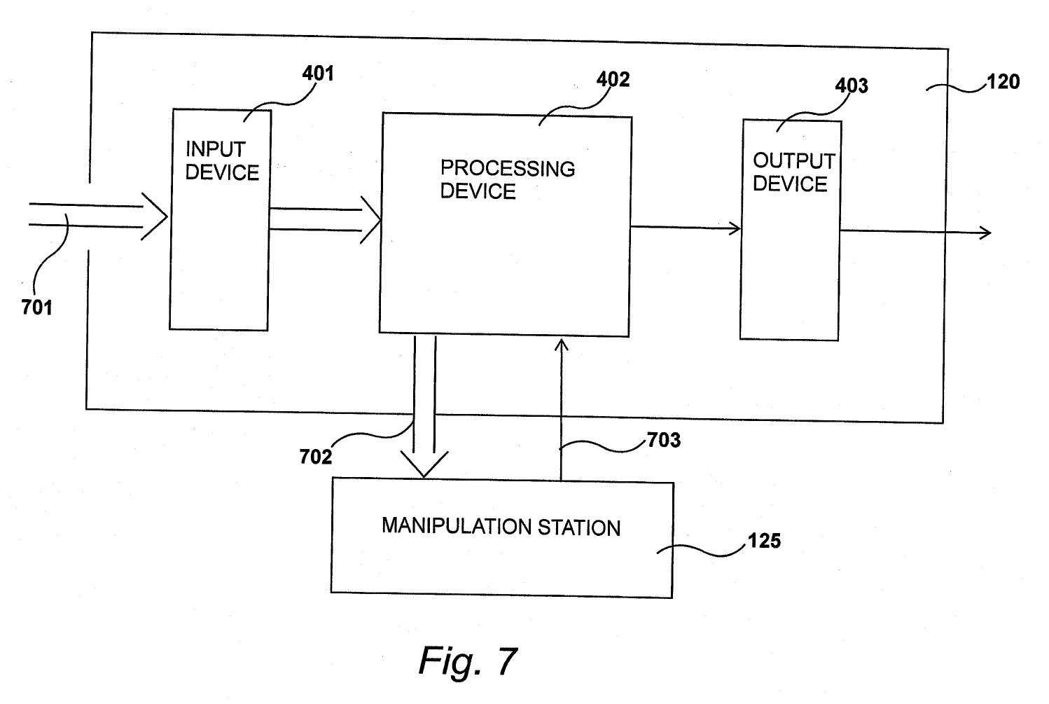

### FIG. 7

Functionality of the environment illustrated in FIG. 5 is shown in FIG. 7. At the traffic manager 120 an input communication 701 is received at input device 401 which in turn conveys this communication to processing device 402. Processing device 402 considers attachments and makes selections for attachments that may be compressed. On identifying an attachment that may be compressed, the attachment is supplied to manipulation station 125 as illustrated by high bandwidth communication 702. At the manipulation station 125 (possibly running a Java application to effect compression) the file is compressed and returned to the processing device 402 as illustrated by low bandwidth communication 703. Thereafter, processing device 402 is configured to assemble a modified electronic communication having, where appropriate, compressed attachments. Output device 403 then conveys the modified electronic mail communication, with compressed attachments, to a receiving server computer.

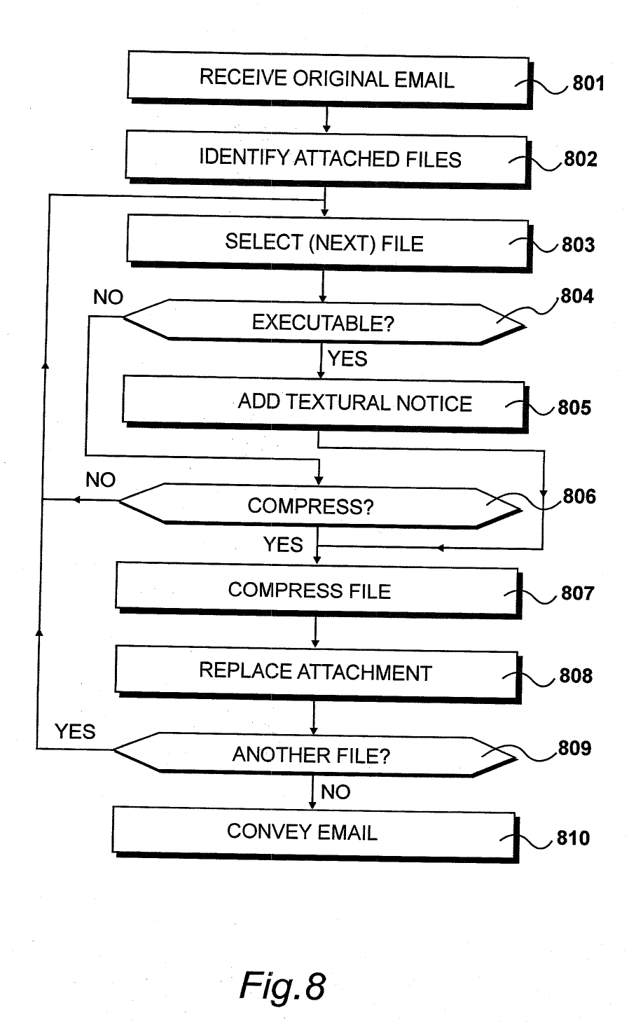

### FIG. 8

Procedures performed within the embodiment of FIG. 7 are detailed in FIG. 8.

At step 801 an original email is received and at step 802 attached files are identified. Attached files may be identified by scanning through the received data or reading emails to identify tags or flags pointing to the existence of attachments.

At step 803 a file is selected and a question is asked at step 804 as to whether the file selected at step 803 is an executable file. If the file is identified as an executable file, the question asked at step 804 is answered in the affirmative and a textural notice is added to the body of the email at step 805. Thus, this textural notice may say “beware, file attachments include at least one executable file”.

If the question asked at step 804 is answered in the negative, to the effect that the file is not an executable file, a further question is asked at step 806 as to whether the file is to be compressed. Thus, in accordance with this preferred embodiment, all executable files are compressed and other files may be compressed based on appropriate criteria. For example, if processing capability is available, if the file has not previously been compressed or if the file is over a certain size the question asked at step 805 may be answered in the affirmative. Thus, at step 807 file compression takes place; these being files that are executable or files that are not executable but are still considered appropriate for compression to take place, on the assumption that sufficient processing capability is available.

After file compression at step 807, the attachment is replaced at step 808. Thus, the non-compressed attachment is replaced with the compressed attachment produced at step 807.

At step 809 a question is asked as to whether another file is present as an attachment and when answered in the affirmative control is returned to step 803 resulting in the next file being selected.

Eventually, the question asked at step 809 will be answered in the negative, such that all of the files have been considered. The email is then conveyed to the next stage at step 810.

An aspect of the present invention is directed towards the compression of executable programs which in turn ensures that an executable program may be transmitted as an attachment without fear of the program executing on the recipient computer automatically. However, a recipient needs to be aware that a compressed file received in this way does represent an executable program so that appropriate measures may be taken before effecting a local decompression process.

As previously described, the input device 401 receives electronic mail communications that include body text and one or more original file attachments in the form of executable programs. The processing device 402 selects the original file attachments that are executable programs to produce selected file attachments. Thus, this embodiment is primarily concerned with identifying executable programs included as attachments so as to reduce the risk of these programs being executed automatically. To ensure that a recipient is aware of the nature of the attachments, the processing device 402 also adds a textural notice to the body of the electronic mail communication to the effect that an executable file is included as an attachment. The processing device 402 compresses the selected file attachments to produce compressed file attachments. The processing device 402 then replaces the selected file attachments with the compressed file attachments to produce a modified electronic mail communication. The output device 403 then conveys the modified electronic mail communication with the compressed attachments to a receiving server computer.

An advantage of performing compression upon the executable programs included as attachments is to ensure that they cannot execute automatically when received. In some environments, this represents a greater advantage compared to performing compressions just to reduce bandwidth. Preferably, compression of other files may take place in addition to the compression of executable programs, subject to the availability of processing capabilities. Thus, it as been appreciated that this level of functionality may be included within Internet systems by using traffic management apparatus. Subject to the level of processing capability available at traffic management apparatus, priority may be given to the compression of executable programs with processing capability also being available for compressing non-executable programs when demand is not being placed the platform by other processers.

The processing device 402 may therefore compress non-executable data files in addition to the compression of executable files so as to reduce transmission bandwidth, when processing capability is available. The processing device 402 may also select files for compression if it identifies them as not having being compressed previously. Alternatively, or in addition, processing device 402 may compress attached data files if their data volume is greater than a predetermined threshold.

1. A traffic management apparatus for connection within a data transmission network arranged to manage the distribution of data traffic between a plurality of data serving computers and data relaying devices by analysing client requests, comprising an input device, a data processing device and an output device, wherein:
said input device is configured to receive electronic mail communications that include body text and one or more original file attachments in the form of executable programs;
said processing device is configured to select said original file attachments that are executable programs to produce selected file attachments;
said processing device is configured to add a textural notice to said body text to the effect that an executable file is included as an attachment;
said processing device is configured to compress said selected file attachments to produce compressed file attachments;
said processing device is configured to replace said selected file attachments with said compressed file attachments to produce a modified electronic mail communication; and
and said output device is configured to convey said modified electronic mail communication with said compressed attachments to a receiving server computer.

2. The apparatus of claim 1, wherein non-executable data files are compressed in addition to executable files to reduce transmission bandwidth.

3. The apparatus of claim 2, wherein said non-executable data files are compressed if they are identified as not having been compressed previously.

4. The apparatus of claim 2, wherein said non-executable data files are compressed if their data volume is greater than a pre-determined threshold.

5. The apparatus of claim 2, wherein non-executable data files are compressed if they are identified as not having been compressed previously and their data volume is greater than a predetermined threshold.

6. The apparatus of claim 1, wherein said traffic management apparatus modifies a client request before requesting data from a server computer.

7. The method of claim 1, wherein said traffic management apparatus:
modifies content data received from a server computer to produce modified data; and
supplies said modified data to a requesting client.

8. In a traffic management apparatus for connection within a data transmission network arranged to manage the distribution of data traffic between a plurality of data serving computers and data relaying devices by analysing client requests, a method of processing electronic mail communications that include body text and one or more original file attachments in the form of executable programs, comprising the steps of:
selecting said original file attachments that are executable programs to produce selected file attachments;
adding a textural notice to said body text to the effect that an executable file is included as an attachment;
compressing said selected file attachments to produce compressed file attachments; and
replacing said selected file attachments with said compressed file attachments to produce a modified electronic mail communication.

9. The method of claim 8, further comprising the step of compressing non-executable data files in addition to executable files to reduce transmission bandwidth.

10. The method of claim 9, wherein said non-executable data files are compressed if they are identified as not having been compressed previously.

11. The method of claim 9, wherein said non-executable data files are compressed if their data volume is greater than a pre-determined threshold.

12. The method of claim 9, wherein non-executable data files are compressed if they are identified as not having been compressed previously and their data volume is greater than a predetermined threshold.

13. The method of claim 8, further comprising the step of modifying a client request before requesting data from a server computer.

14. The method of claim 8, further comprising the steps of:
modifying content data received from a server computer to produce modified data; and
supplying said modified data to a requesting client.
